(19) United States
(12) Patent Application Publication
(10) Pub. No.: US 2010/0289958 A1
(43) Pub. Date: Nov. 18, 2010

(54) Method and Apparatus for Assisting a Person In Configuring an Audio/Video System

(76) Inventors: Suraj C. Iyer, Bolton, MA (US); William Berardi, Grafton, MA (US); Christine M. Hostage, Southborough, MA (US); Leela Keshavan, Westborough, MA (US); Valerie S. Liebhold, Ashland, MA (US); Andrew Olcott, Newtonville, MA (US); John Michael Sakalowsky, West Newton, MA (US); Conor Sheehan, Arlington, MA (US); Lee Zamir, Cambridge, MA (US)

Correspondence Address: Bose Corporation;c/o Donna Griffiths, The Mountain, MS 40, IP Legal - Patent Support, Framingham, MA, 01701, US

(21) Appl. No.: 12/465,763

(22) Filed: May 14, 2009

(51) Int. Cl. H04N 5/46

(52) U.S. Cl. 348/555; 348/E05.114

(57) ABSTRACT

An audio/video switchbox includes a housing and one or more jacks on the housing. Each jack is configured to be connected to an end of a signal cable. A logic and control controls operation of the switchbox. The switchbox is connectable to a video display so that video images from the switchbox can be presented on the display. The switchbox is able to present an image on the display requesting that a person indicate which type of signal cable will be used to connect an audio/video device to the switchbox. The switchbox is able to automatically detect when an end of a signal cable selected by the person has been connected to one of the jacks.

### BACKGROUND

This disclosure relates to methods and apparatus for assisting a person in configuring an audio/video system.

### SUMMARY

According to a first aspect, a method of assisting a person in configuring an audio/video system includes the step of indicating on a video display that the person should select an audio/video device to configure from a plurality of audio/video devices listed on the video display. An instruction is provided on the video display that a selected audio/video device should be disconnected from the video display after the person has indicated that the selected audio video device is connected to the video display.

A request can be shown on the video display that the person should indicate which type of signal cable will be used to connect the selected audio/video device to an audio/video switchbox which is connected to the video display. During the requesting step one or more images of one or more ends for one or more signal cables can be presented on the video display. The person is instructed via the video display to connect an end of a selected signal cable to a jack on the selected audio/video device. During the instructing step an image of the jack and the end of the selected signal cable can be shown on the video display. During one or more of the indicating, providing, requesting and instructing steps an image of a remote control can be presented on the video display, one or more buttons on the image of the remote control being highlighted to indicate that the person should use those one or more buttons on their remote control to make a selection. The person is instructed via the video display to connect an end of a selected signal cable to a jack on the audio/video switchbox. It can be automatically detected that the end of the selected signal cable has been connected to the jack. It can be attempted to present by the video display one or more of audio and video from the selected audio/video device. The person can be asked via the video display to indicate whether or not they can perceive one or more of the audio and video presented by the video display in order to confirm that the video display device, audio/video switchbox and selected audio/video device are properly connected. A temporary visual indicator can be provided adjacent to the jack on the audio/video switchbox. The temporary visual indicator can be automatically extinguished after the switchbox automatically detects that the end of the selected signal cable has been connected to the jack.

According to a second aspect, an audio/video switchbox includes a housing and one or more jacks on the housing. Each jack is configured to be connected to an end of a signal cable. A logic and control controls operation of the switchbox. The switchbox is connectable to a video display so that video images from the switchbox can be presented on the display. The switchbox is able to present an image on the display requesting that a person indicate which type of signal cable will be used to connect an audio/video device to the switchbox. The switchbox is able to automatically detect when an end of a signal cable selected by the person has been connected to one of the jacks.

The switchbox can provide an image to the display which requests the person to select an audio/video device to configure from a plurality of audio/video devices listed on the display. The switchbox can provides an image of a remote control for presentation on the display, one or more buttons on the image of the remote control being highlighted to indicate that the person should use those one or more buttons on their remote control to make a selection. The switchbox can provide an image to the display which instructs that the audio/video device should be disconnected from the video display after the person has indicated that the audio video device is connected to the video display. a temporary visual indicator can be provided adjacent to the one of the jacks to which the end of the signal cable is to be connected.

According to a third aspect, a method of assisting a person in configuring an audio/video system includes the step of presenting an image on a video display connected to an audio/video switchbox that requests a person to indicate which type of signal cable will be used to connect an audio/video device to the switchbox. It is automatically detected when an end of a signal cable selected by the person has been connected to a jack on the switchbox.

The switchbox can provide an image to the display which requests the person to select an audio/video device to connect to the switchbox from a plurality of audio/video devices listed on the display. The switchbox can provide an image to the display which instructs that an end of a selected signal cable should be connected to a jack on the audio/video device.

According to a fourth aspect, a method of connecting an audio/video device to a video display device includes the step of providing an instruction on an image presentation portion of the display device to connect a signal cable to at least one jack out of a plurality of jacks that are located adjacent to the presentation portion. A visual reference is presented on the presentation portion which is directed at the at least one jack.

The visual reference can be an arrow pointed at the at least one jack A temporary visual indicator can be provided adjacent to the at least one jack.

According to a fifth aspect, a method of connecting a signal cable to a device includes the step of indicating that the cable should be plugged into a first jack on the device. It can be automatically detected that the cable has been plugged into a second jack on the device. A user of the device is informed that the cable has been plugged into a non-indicated jack.

After the informing step the indicating step is repeated. The informing step can include giving the user a choice of leaving the cable plugged into the second jack. According to a sixth aspect, a method of connecting a signal cable to a device includes the step of indicating that the cable should be plugged into a jack on the device. A temporary visual indicator is provided adjacent to the jack.

The temporary visual indicator can be a light emitting diode.

### BRIEF DESCRIPTION OF THE DRAWINGS

FIG. 1 is a schematic representation of an audio video system;

FIG. 2 is a rear view of an audio/video switchbox;

FIG. 3 is a partial sectional view of an audio input jack;

FIGS. 4-22 are screen shots of information used to assist a person in configuring their audio/video system;

FIG. 23 is a schematic representation of the audio video system of FIG. 1 after the system has been configured; and

FIG. 24 is a schematic representation of a video display device with front audio/video jacks.

### DETAILED DESCRIPTION

Many consumers choose to add a home theatre audio/video system to their TV setup to enhance their TV viewing experience. Prior to purchasing this system, the consumer may already have, for example, a cable box and a DVD player connected to their TV. It can often be a confusing process to integrate the home theatre system into the exiting audio/video components. A switchbox in the home theatre system can have a confusingly large number of jacks for inputting and outputting audio and video to/from the switchbox. The detailed description below discloses how to assist a person in connecting audio/video devices to the switchbox once the switchbox has been connected to the TV.

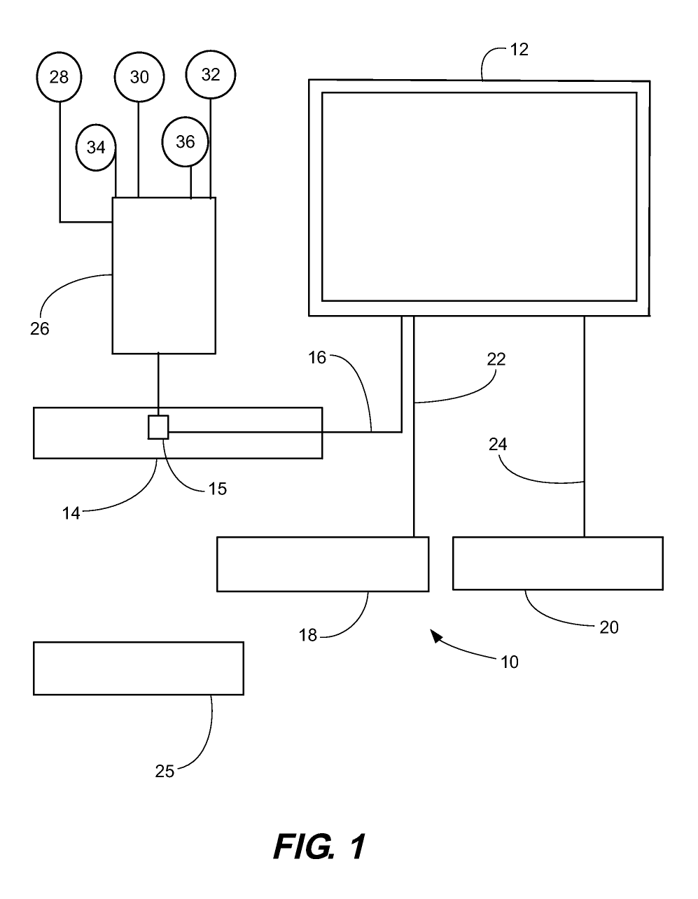

FIG. 1 discloses an initial state of an audio/video system 10 which includes a video display device 12 such as a liquid crystal or plasma display. The display 12 typically includes integrated speakers (not shown). An audio/video switchbox 14 is connected to the video display device 12 by, for example, a High Definition Multimedia Interface (HDMI) cable 16. As such, video images from the switchbox 14 can be presented on the display 12. An audio/video switchbox is an electronic device that includes (a) one or more inputs for receiving audio and/or video from another electronic device, and (b) one or more outputs for transmitting audio and/or video to another electronic device. A pair of audio/video devices, such as a cable box 18 and a digital video disc (DVD) player 20 are also attached to the display 12 by, for example, a respective HDMI cables 22 and 24. An additional audio video device, such as a satellite box 25, has not yet been connected to the system 10. A bass speaker 26 is connected to switchbox 14. Five additional speakers 28, 30, 32, 34 and 36 are connected to the bass speaker 26. Speakers 26, 28, 30, 32, 34 and 36 make up what would typically be called a 5.1 surround sound system. Speaker 28, 30, 32, 34 and 36 would actually be located as follows in a real system: speakers 28 and 32 respectively to the left and right of the display 12, speaker 30 just above or below the display, and speakers 34 and 36 in the back corners of the room in which the display is located. The switchbox 14 includes a logic and control portion 15 which interfaces with the display 15, the bass speaker 26, and other devices which may be connected to the switchbox 14. The logic and control 15 controls operation of the switchbox 14.

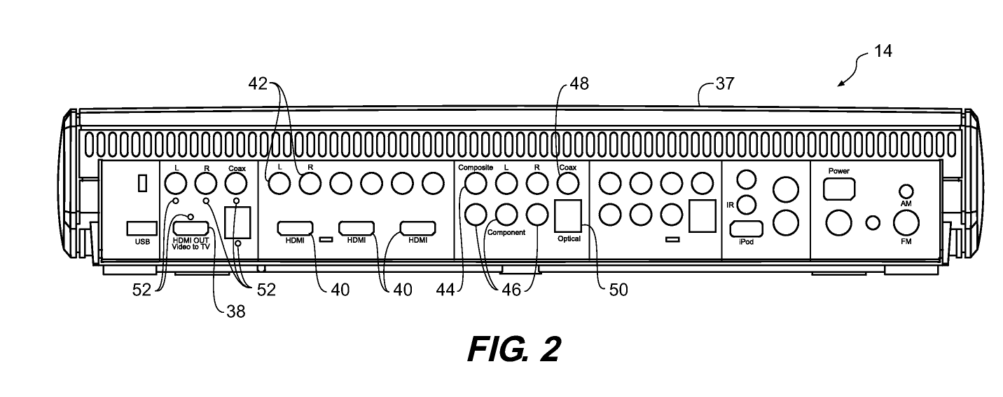

Turning to FIG. 2, a back portion of the audio/video switchbox 14 includes a housing 37 and a large number of input/output ports or jacks which are each configured to be connected to an end of a signal cable. Only some of the jacks in FIG. 2 have been labeled in order to not over-clutter the drawing. The switchbox 14 includes an HDMI OUT jack 38, three HDMI input jacks 40, left and right audio input jacks 42, a Composite video input jack 44, Component video input jacks 46, a Coaxial input jack 48, and an optical input jack 50. At least jacks 40, 42, 44 and 46 are each able to automatically detect that a signal cable has been connected to the jack or removed from the jack and report that status to a processor in the switchbox 14. Further details of this automatic detection are provided below. The swtchbox 14 also includes a number of temporary visual indicators in the form of light emitting diodes (LEDs) 52 which are each located adjacent to a respective jack. Not all of the LEDs are shown in FIG. 2 in order to avoid cluttering up the drawing. The purpose of the LEDs will be explained below.

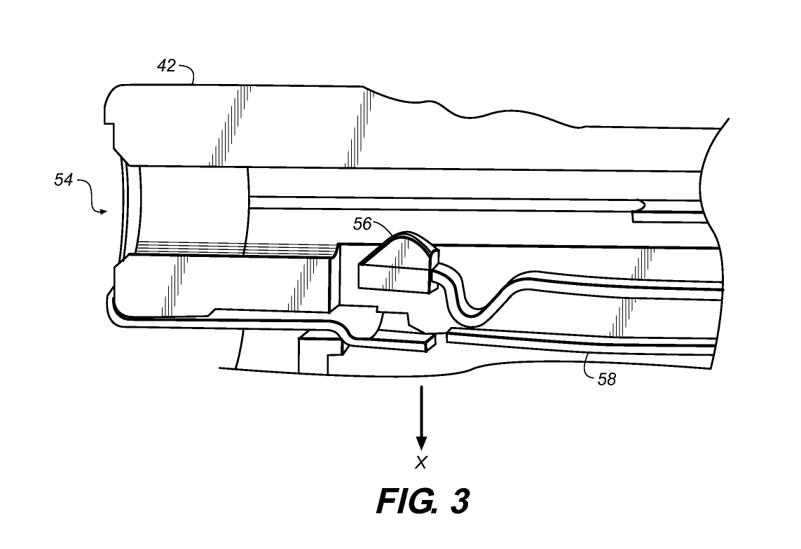

With reference to FIG. 3, a partial sectional view of the audio input jack 42 is shown. The jack 42 is an RCA jack which is well known to those skilled in the art. RCA jacks are used for any audio jacks and composite jacks (including jack 44) on the switchbox 14. The jack 42 includes a hollow volume 54 which is generally cylindrical in shape. An RCA plug (not shown) at an end of a communication cable is inserted into the volume 54 and comes into contact with a first portion 56 of an electrical switch which initially is in an open state. As the plug is pushed further into the volume 54 the plug forces the first switch portion 56 to move in a direction X. As a result, the first switch portion 56 is pressed against a second switch portion 58 to close the switch. The effect of this is that the insertion of the plug into jack 42 is automatically detected and reported to the logic and control 15 of the switchbox 14. Removal of the plug is from the jack 42 is thus also automatically detected and reported to the logic and control when the switch returns to an open state. This same type of arrangement can be used in other types of jacks on the switchbox 14 such as the component jacks 46 and the optical jack 50. The HDMI jacks automatically detect and report insertion or removal of an HDMI cable through at least one of its numerous electrical contacts which interface with corresponding electrical contacts on an HDMI cable.

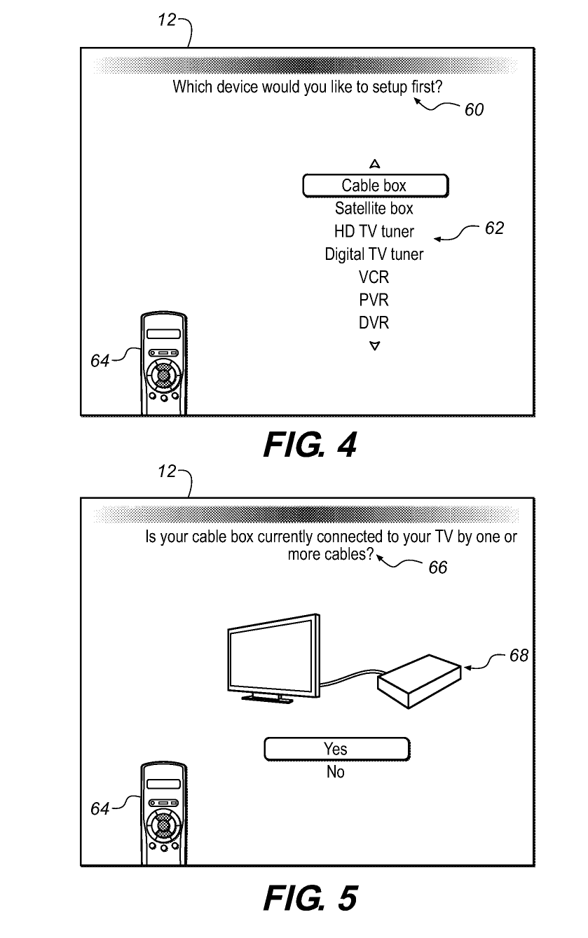

With reference to FIGS. 1 and 4, once the switchbox 14 is connected to the display 12 and powered up for the first time, the information shown in FIG. 4 is presented on the display 12. Even after the system has been used for a period of time, a person can return to the following setup/configuration/reconfiguration procedure at any time by making a particular selection from the system menu. An indication 60 (an image) is provided from the switchbox 14 to the video display 12 requesting that a person using the system should select an audio/video device to configure from a plurality of audio/video devices 62 listed on the video display. An image of a remote control 64 is provided by the switchbox 14 to the display 12. One or more buttons on the remote control 64 are highlighted to indicate that the person should use those one or more buttons on their remote control to make a selection. In this case the up and down arrows as well as the “OK” (select) buttons are highlighted (shown as hatched areas in the figure). Here the person has used one or more of the highlighted buttons to select “Cable box” to setup first. When the “OK” button is pressed, the system proceeds to the next screen image.

With reference to FIGS. 1 and 5, the cable box 18 is currently connected to the display 12. In FIG. 5 the switchbox 14 provides an image to the display 12 in which the person is asked at 66 if their cable box is currently connected to their TV (display) by one or more cables. The person has selected “Yes” using buttons on their remote control highlighted on the remote control image 64. This indicates that the cable box 18 is connected to the TV. An image 68 of an audio/video device connected to a TV by a cable is shown on the display 12.

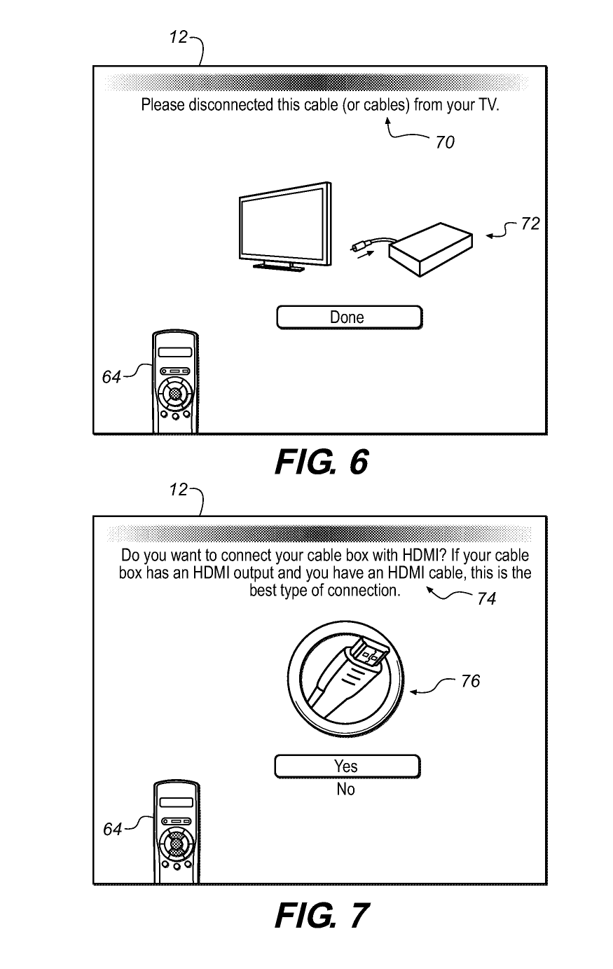

In FIG. 6 the switchbox 14 provides an image to the display 12 that includes an instruction 70 for the person to disconnect the cable(s) from their TV, thereby disconnecting the cable box 18 from the display 12. The person has selected “Done” using the button on their remote control highlighted (hatched) on the remote control image 64. An image 72 of an audio/video device disconnected from a TV by a cable is shown on the display 12. Turning to FIG. 7, an image is provided by the switchbox 14 and presented on the display 12 requesting that the person indicate which type of signal cable will be used to connect the cable box 18 to the switchbox 14. This is effected by asking the person at 74 if they want to connect their cable box with an HDMI cable. An image 76 of an end of an HDMI cable is shown on the display 12. The person has selected “Yes” using the buttons on their remote control highlighted on the remote control image 64.

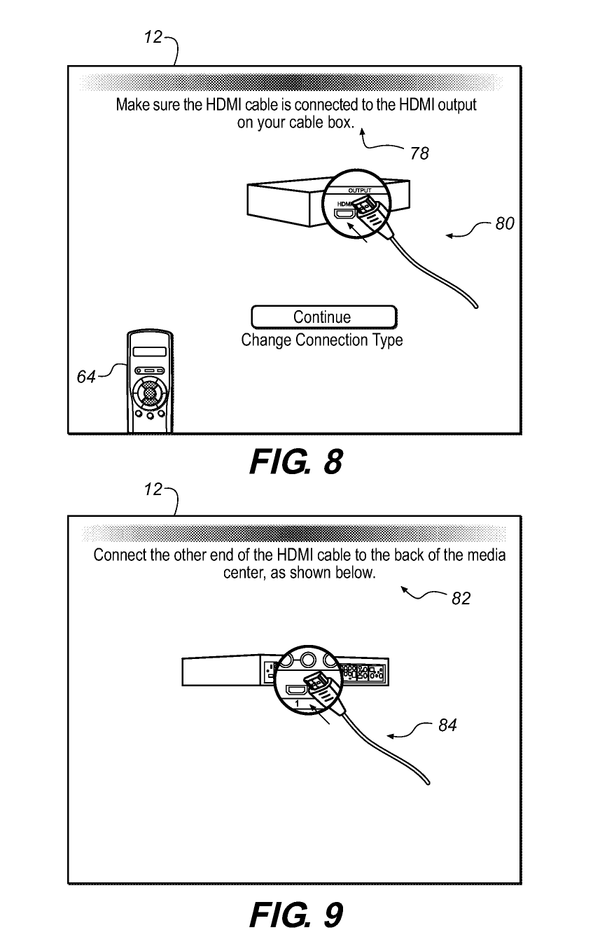

Referring to FIG. 8, the switchbox 14 provides an image to the display 12 that includes an instruction 78 that the person should connect an end of the selected HDMI cable to a jack (HDMI output) on the cable box. An image 80 of an end of an HDMI cable and an HDMI output jack on an audio/video device is shown on the display 12. The person has selected “Continue” using the buttons on their remote control highlighted on the remote control image 64.

As shown in FIG. 9, an instruction 82 is provided by the switchbox 14 and presented on the video display that the person should connect the other end of the selected HDMI signal cable to a jack on the switchbox 14. An image 84 of an end of an HDMI cable and an HDMI input jack on the switchbox 14 is shown on the display 12. An LED 52 (see FIG. 3) adjacent to an appropriate HDMI input jack on the switchbox 14 is temporarily illuminated to assist the person in connecting an end of the HDMI cable to the correct HDMI jack. Note that there is not an image of a remote control shown in FIG. 9. This is because the logic and control 15 of the switchbox 14 automatically detects by an interrupt or polling arrangement when the end of the HDMI cable has been connected to the HDMI jack on the switchbox 14. The LED is extinguished after the logic and control 15 automatically detects that the end of the HDMI cable has been connected to the HDMI jack on the switchbox 14. An optional pleasant sounding audio sound (e.g. a chime) can be emitted by a small speaker (not shown) in the switchbox 14 when the end of the HDMI cable has been connected to the indicated HDMI jack. If the end of the HDMI cable is plugged into a non-indicated HDMI jack on the switchbox 14, then an unpleasant audio sound (e.g. a buzzer) can be emitted. There is no need for the person to indicate that this step has been completed.

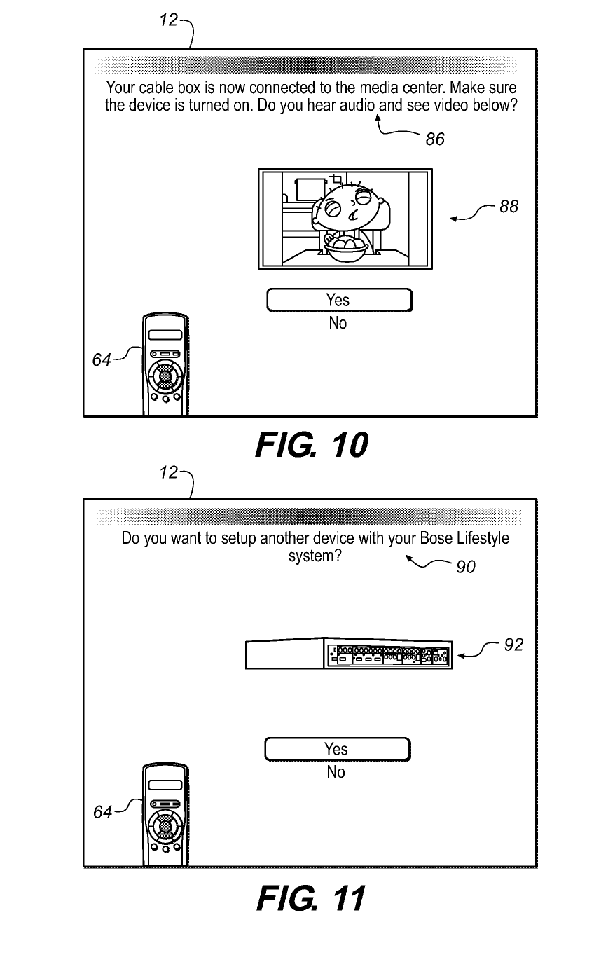

With reference to FIG. 10, the person is now informed at 86 by the display that the cable box is connected to the media center (i.e. switchbox). The person is told to make sure the cable box is turned on. The system attempts to present by the video display 12 one or more of audio and video from the cable box. The person is asked at 86 to indicate whether or not they can perceive one or more of the audio and video 88 presented by the video display 12 in order to confirm that the video display device, switchbox 14 and cable box are properly connected. The person has selected “Yes” using buttons on their remote control highlighted on the remote control image 64.

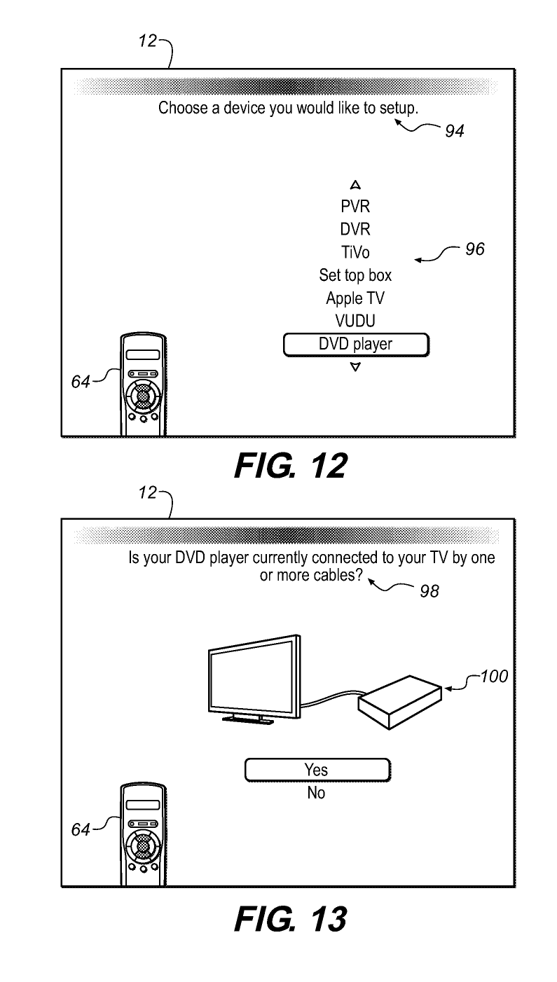

Turning to FIG. 11, the switchbox 14 provides an image to the display in which a query 90 is provided asking the person if they want to setup another device to work with the switchbox 14 (Bose® Lifestyle® system). An image 92 of the switchbox 14 is shown on the display 12. The person has selected “Yes” using the buttons on their remote control highlighted on the remote control image 64. Referring to FIG. 12, the switchbox 14 provides an image to the display in which an indication 94 is provided that the person should select an audio/video device to configure from a plurality of audio/video devices 96 listed on the display 12. The person has selected “DVD player” using the buttons on their remote control highlighted on the remote control image 64. When the “OK” button is pressed, the system proceeds to the next screen image.

With reference to FIG. 1 and 13, the DVD player 20 is currently connected to the display 12. In FIG. 13 the switchbox 14 provides an image to the display in which the person is asked at 98 if their DVD player is currently connected to their TV (display) by one or more cables. The person has selected “Yes” using buttons on their remote control highlighted on the remote control image 64. This indicates that the DVD player 20 is connected to the TV. An image 100 of an audio/video device connected to a TV by a cable is shown on the display 12.

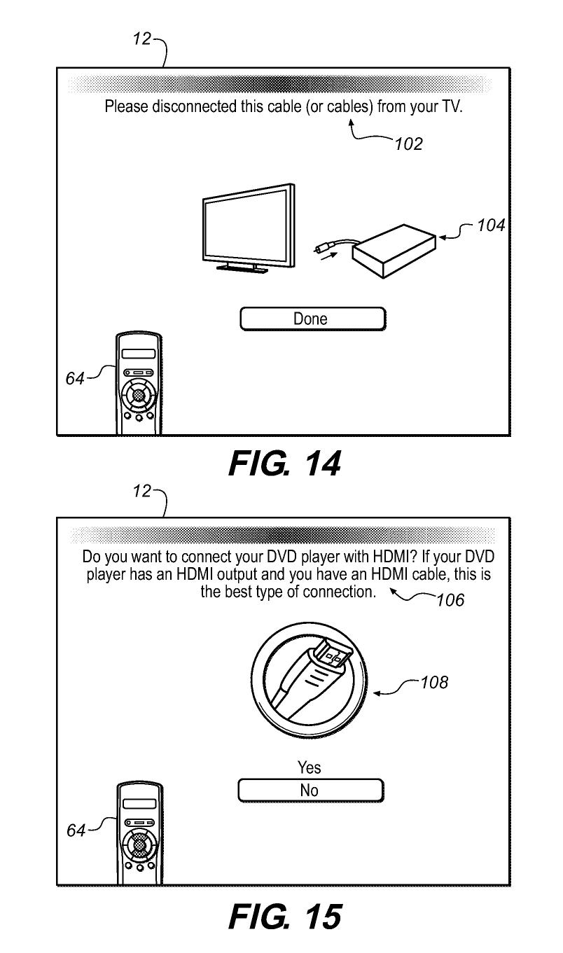

In FIG. 14 the switchbox 14 provides an image to the display in which an instruction 102 is provided to the person to disconnect the cable(s) from their TV. An image 104 of an audio/video device disconnected from a TV is shown on the display 12. The person has selected “Done” using the button on their remote control highlighted on the remote control image 64. Turning to FIG. 15, the switchbox 14 provides an image to the display in which a request is presented on the video display that the person indicate which type of signal cable will be used to connect the DVD player 20 to the switchbox 14. This is effected by asking the person at 106 if they want to connect their DVD player with an HDMI cable. An image 108 of an end of an HDMI cable is shown on the display 12. The person has selected “No” using the buttons on their remote control highlighted on the remote control image 64.

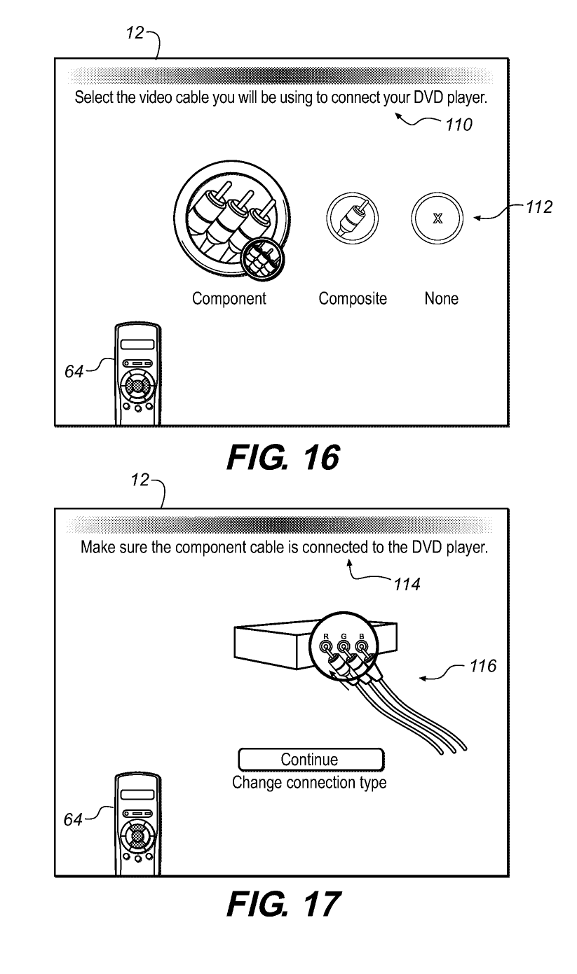

In response, the switchbox 14 provides an image to the display 12 that is shown in FIG. 16. An instruction 110 is provided on the display 12 to the person to select the video cable they will use to connect the DVD player 20 to the switchbox 14. An image 112 of component cable ends, a composite cable end, and no cable is shown on the display 12. The person has selected “Component” using the button on their remote control highlighted on the remote control image 64.

Referring to FIG. 17, the switchbox 14 provides an image to the display in which an instruction 114 is presented on the video display 12 that the person should connect the ends of the selected component cable to jacks (Component output) on the DVD player. An image 116 of the ends of a component cable and component output jacks on a DVD player is shown on the display 12. The person has selected “Continue” using the buttons on their remote control highlighted on the remote control image 64.

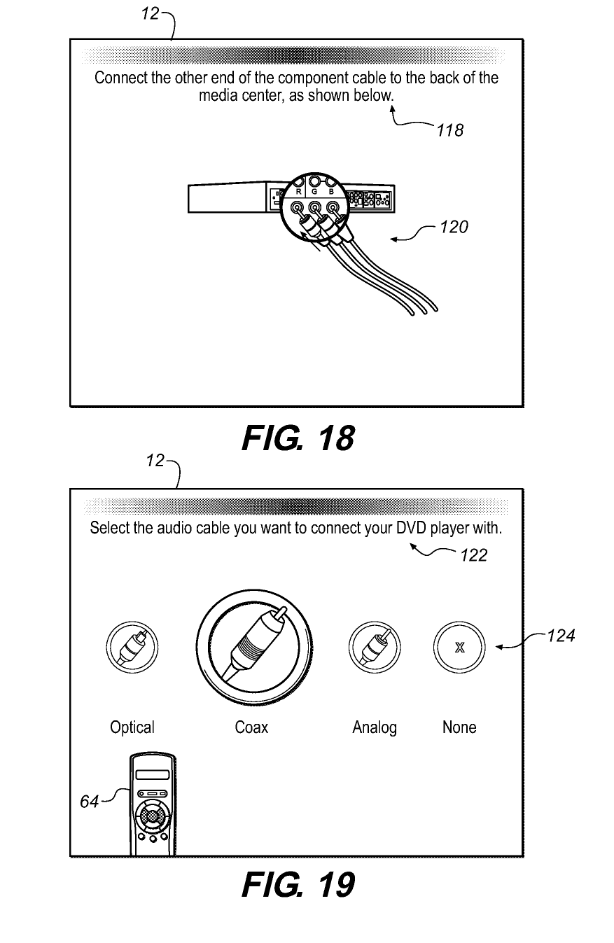

As shown in FIG. 18, the switchbox 14 provides an image to the display in which an instruction 118 is presented on the video display that the person should connect the other ends of the selected component signal cable to jacks on the switchbox 14 (media center). An image 120 of the ends of a component cable and component input jacks on the switchbox 14 is shown on the display 12. Note that there is not an image of a remote control shown in FIG. 18. This is because the logic and control 15 of the switchbox 14 automatically detects when the ends of the component cable have been connected to the component jacks on the switchbox 14. There is no need for the person to indicate that this step has been completed.

Referring to FIG. 19, as the component cable only transmits video information between the switchbox 14 and the DVD player 20, a separate audio connection should be established between these two devices. The switchbox 14 provides an image to the display in which an instruction 122 is presented on the video display that the person should select the audio cable they will use to connect the DVD player 20 to the switchbox 14. An image 124 of the ends of an optical cable, a coax cable, an analog cable, and no cable is shown on the display 12. The person has selected “Coax” using the buttons on their remote control highlighted on the remote control image 64.

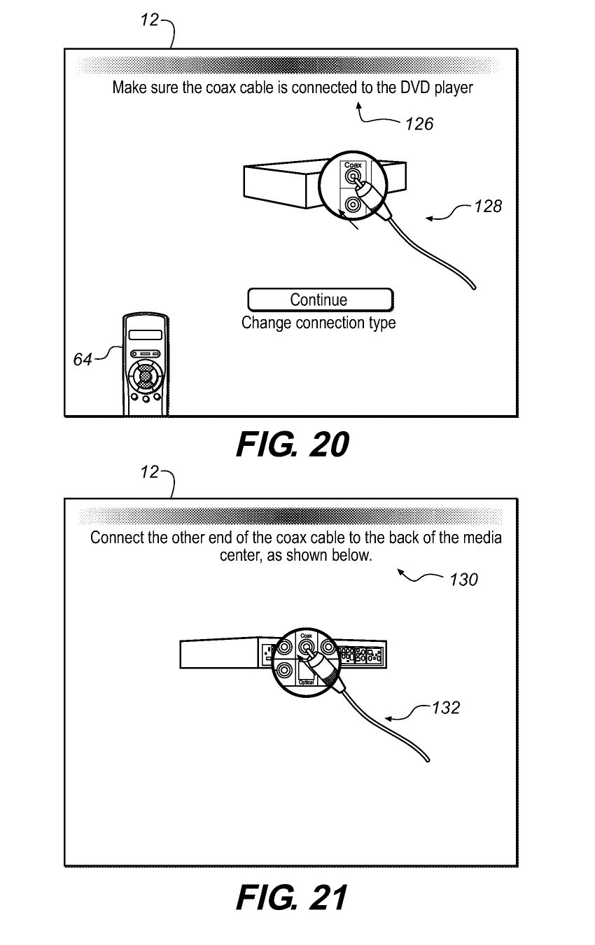

Referring to FIG. 20, an instruction 126 is provided by the switchbox 14 and presented on the video display 12 that the person should make sure the coax cable is connected to the DVD player. An image 128 of the end of a coax cable and coax output jack on a DVD player is shown on the display 12. The person has selected “Continue” using the buttons on their remote control highlighted on the remote control image 64.

As shown in FIG. 21, the switchbox 14 provides an image to the display in which an instruction 130 is presented on the video display 12 that the person should connect the other end of the selected coax cable to the back of the switchbox 14 (media center). An image 132 of the end of a coax cable and coax input jack on the switchbox 14 is shown on the display 12. Note that there is not an image of a remote control shown in FIG. 21. This is because the logic and control 15 of the switchbox 14 automatically detects when the ends of the coax cable have been connected to the coax jack on the switchbox 14. There is no need for the person to indicate that this step has been completed.

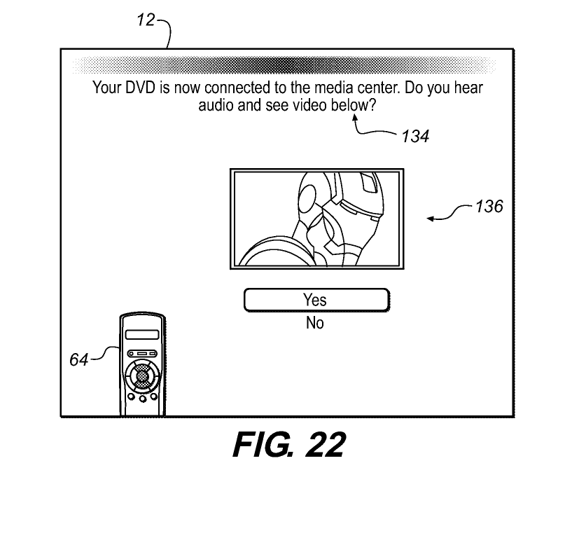

With reference to FIG. 22, the switchbox 14 provides an image to the display 12 in which the person is now informed at 134 by the display that the DVD player is now connected to the media center (i.e. switchbox 14). The system automatically attempts to present by the video display 12 one or more of audio and video from the DVD player 20. The person is asked at 134 to indicate whether or not they can perceive one or more of the audio and video 136 presented by the video display 12 in order to confirm that the video display device 12, switchbox 14 and DVD player 20 are properly connected. The person has selected “Yes” using buttons on their remote control highlighted on the remote control image 64.

Returning to FIG. 1, in the initial state of the audio/video system 10, the satellite box 25 was not connected to the system. The disclosure above for configuring the cable box 18 and the DVD player 20 can also be used to configure the satellite box 25. The main difference is that when the person was asked if their satellite box was currently connected to their TV by one or more cables (see FIG. 5), the person would respond “No”. The system would then skip the next step (see FIG. 6) of disconnecting the satellite box from the display (e.g. TV) and proceed directly to signal cable selection (FIG. 7).

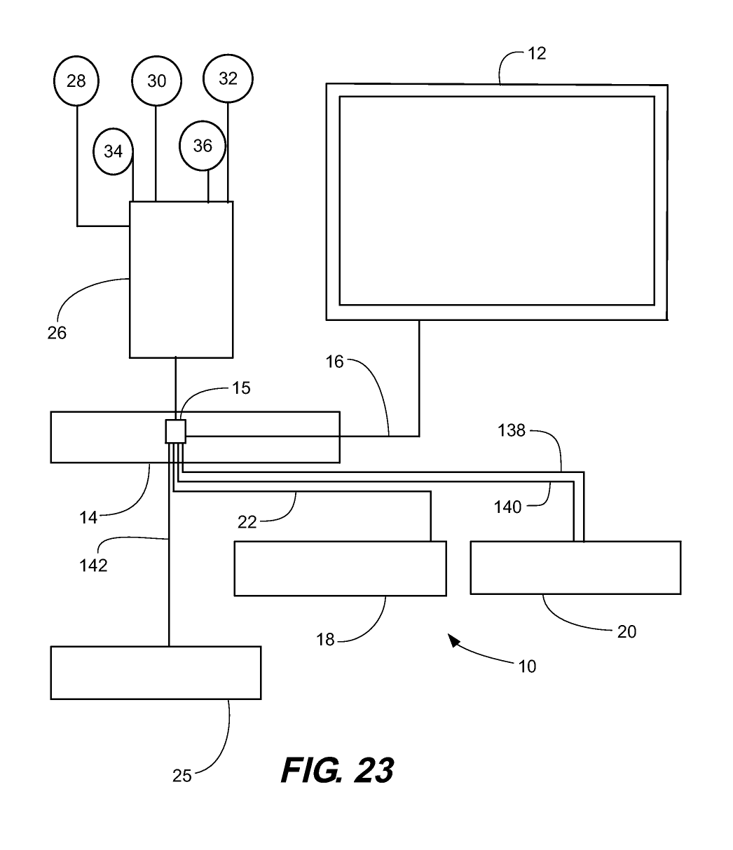

After the audio/video system 10 has been configured according to the above disclosure, it will appear as shown in FIG. 23. The cable box 18 is now connected to the switchbox 14 with the HDMI cable 22. The DVD player 20 is now connected to the switchbox 14 with a component cable 138 and a coax cable 140. The satellite box 25 is now connected to the switchbox 14 with an HDMI cable 142. The above disclosure can be used at initial setup of the system 10 or at any time to configure or reconfigure system 10.

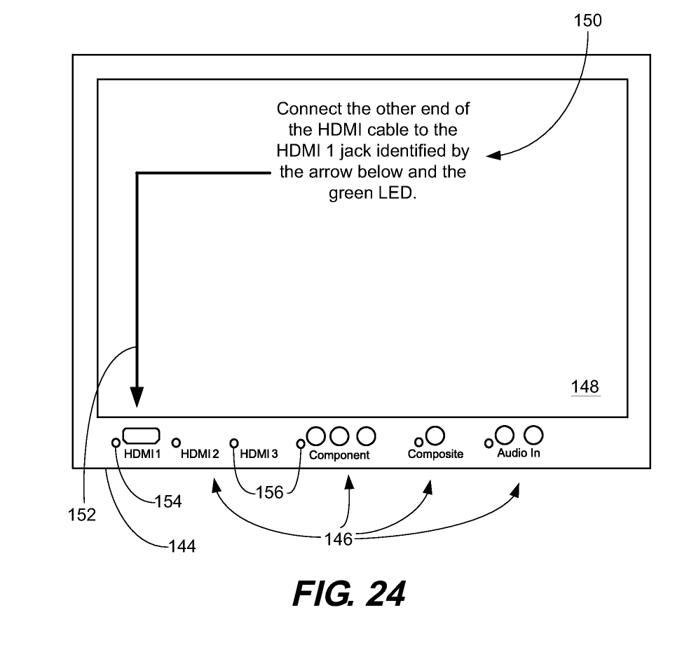

FIG. 24 discloses another example in which a video display 144 includes a number of front audio/video jacks 146 adjacent to an image presentation portion 148 of the video display 144. The video jacks and image presentation portion 148 are viewable simultaneously by a person standing in front of the display 12. In this example a person is being provided with assistance in connecting an audio video device (not shown) to their TV (video display 144). The person selects the type of video and/or audio cable they want to use to make the connection as described above (see FIGS. 7, 15, 16 and 19). They are then instructed to connect one end of the cable(s) to the audio/video device (e.g. a gaming system) they want to connect to their TV as described above (see FIGS. 8, 17 and 20). Next, an instruction 150 is presented on the image presentation portion which directs the person to connect the other end of the HDMI cable to the HDMI 1 jack identified by an arrow 152 (visual reference) below and the green LED 154.” Just prior to the instruction 150 being presented, the LED 154 is illuminated. Other LEDs 156 are located adjacent to other ones of the jacks but are not illuminated at this time. Not all of the LEDs are labeled with the reference numeral 156 in order to not over-clutter the drawing.

Insertion of an end of an HDMI cable into the “HDMI 1” jack is automatically detected by the logic and control (not shown) of the video device 144 as described above. If the person plugs an end of the HDMI cable into a different jack (e.g. “HDMI 2”), the system can automatically detect this insertion and inform the user of the device that the cable has been plugged into a non-indicated jack as follows. A visual indication of the error is momentarily provided on portion 148. Instruction 150 is then repeated. Alternatively a query can be presented on portion 148 that asks if they would rather connect the HDMI cable to the HDMI 2 jack. A “Yes” and “No” choice are provided on portion 148 along with an image of a remote control with highlighted buttons (as described above). If the person selects “Yes”, the system proceeds to its next step. If the person selects “No”, the instruction 150 is repeated. This assistance with helping a person when they have plugged a signal cable into a non-indicated jack can also be provided in the example described above and shown in FIGS. 1-23.

While the invention has been particularly shown and described with reference to specific exemplary embodiments, it is evident that those skilled in the art may now make numerous modifications of, departures from and uses of the specific apparatus and techniques herein disclosed. Consequently, the invention is to be construed as embracing each and every novel feature and novel combination of features presented in or possessed by the apparatus and techniques herein disclosed and limited only by the spirit and scope of the appended claims.

What is claimed is:

1. An audio/video switchbox, comprising:
a housing;
one or more jacks on the housing, each jack being configured to be connected to an end of a signal cable; and
a logic and control for controlling operation of the switchbox, the switchbox being connectable to a video display so that video images from the switchbox can be presented on the display, the switchbox being able to present an image on the display requesting that a person indicate which type of signal cable will be used to connect an audio/video device to the switchbox, the switchbox being able to automatically detect when an end of a signal cable selected by the person has been connected to one of the jacks.

2. The switchbox of claim 1, wherein the switchbox provides an image to the display which requests the person to select an audio/video device to configure from a plurality of audio/video devices listed on the display.

3. The switchbox of claim 1, wherein the switchbox provides an image of a remote control for presentation on the display, one or more buttons on the image of the remote control being highlighted to indicate that the person should use those one or more buttons on their remote control to make a selection.

4. The switchbox of claim 1, wherein the switchbox provides an image to the display which instructs that the audio/video device should be disconnected from the video display after the person has indicated that the audio video device is connected to the video display.

5. The switchbox of claim 1, wherein one or more images of one or more ends for one or more signal cables are presented on the video display.

6. The switchbox of claim 1, wherein the switchbox provides an image to the display which instructs that an end of a selected signal cable should be connected to a jack on the audio/video device.

7. The switchbox of claim 6, wherein an image of the jack on the audio/video device and the end of the selected signal cable is shown on the video display.

8. The method of claim 1, further including a temporary visual indicator adjacent to the one of the jacks to which the end of the signal cable is to be connected.

9. The method of claim 8, the temporary visual indicator is automatically extinguished after the switchbox automatically detects that the end of the signal cable has been connected to the one of the jacks.

10. The method of claim 1, wherein an audio sound is emitted when the end of the signal cable selected by the person has been connected to one of the jacks.

11. A method of assisting a person in configuring an audio/video system, comprising the steps of:
presenting an image on a video display connected to an audio/video switchbox that requests a person to indicate which type of signal cable will be used to connect an audio/video device to the switchbox; and
automatically detecting when an end of a signal cable selected by the person has been connected to a jack on the switchbox.

12. The method of claim 11, wherein the switchbox provides an image to the display which requests the person to select an audio/video device to connect to the switchbox from a plurality of audio/video devices listed on the display.

13. The method of claim 11, wherein the switchbox provides an image of a remote control for presentation on the display, one or more buttons on the image of the remote control being highlighted to indicate that the person should use those one or more buttons on their remote control to make a selection.

14. The method of claim 11, wherein the switchbox provides an image to the display which instructs that the audio/video device should be disconnected from the video display after the person has indicated that the audio video device is connected to the video display.

15. The method of claim 11, wherein one or more images of one or more ends for one or more signal cables are presented on the video display.

16. The method of claim 11, wherein the switchbox provides an image to the display which instructs that an end of a selected signal cable should be connected to a jack on the audio/video device.

17. The method of claim 16, wherein an image of the jack on the audio/video device and the end of the selected signal cable is shown on the video display.

18. The method of claim 11, further including the step of providing a temporary visual indicator adjacent to the jack on the audio/video switchbox.

19. The method of claim 18, further including the step of automatically extinguishing the temporary visual indicator after the switchbox automatically detects that the end of the signal cable has been connected to the jack.

20. The method of claim 11, wherein an audio sound is emitted when the end of the signal cable selected by the person has been connected to the jack.

21. The method of claim 11, wherein an instruction is provided on an image presentation portion of the video display to connect a signal cable to at least one jack out of a plurality of jacks that are located adjacent to the presentation portion, wherein a visual reference is presented on the presentation portion which is directed at the at least one jack.
